(19) United States
(12) Patent Application Publication
(10) Pub. No.: US 2013/0232148 A1
(43) Pub. Date: Sep. 5, 2013

(54) CONTENT MAPPING

(71) Applicants: Brian Whalen MacDonald, Bellevue, WA (US); Mira Lane, Redmond, WA (US); Phoi Heng Lew, Mill Creek, WA (US); Sudin Bhat, Redmond, WA (US)

(72) Inventors: Brian Whalen MacDonald, Bellevue, WA (US); Mira Lane, Redmond, WA (US); Phoi Heng Lew, Mill Creek, WA (US); Sudin Bhat, Redmond, WA (US)

(73) Assignee: Microsoft Corporation, Redmond, WA (US)

(21) Appl. No.: 13/409,740

(22) Filed: Mar. 1, 2012

(51) Int. Cl. G06F 17/30

(52) U.S. Cl. 707/740; 707/E17.091

(57) ABSTRACT

One or more techniques and/or systems are provided for mapping content to a carousel interface in a manner that allows a user to more intuitively navigate through and/or interact with such content. The carousel interface may be associated with a domain (e.g., a map directions domain, a news domain, etc.). One or more categories associated with the domain may be identified (e.g., a sports news category, a health news category, etc.). In one example, entities (e.g., a Professional Sports Team and/or other proper nouns) and/or topics (e.g., 2012 Olympics) may be identified for respective categories. In this way, content associated with the one or more categories, entities, and/or topics may be retrieved and/or populated within one or more carousels of the carousel interface in an intuitive manner (e.g., sports articles may be populated within a sports carousel, health articles may be populated within a health carousel, etc.).

### BACKGROUND

Today, many applications implement gesture-based interaction models for displaying and/or interacting with content. In one example, an image viewing application on a tablet device may allow users to navigate images using finger swipe gestures (e.g., horizontal swipes for horizontal scrolling, vertical swipes for vertical scrolling, etc.). In another example, a map application on a mobile device may allow users to explore a map using finger swipe gestures. Because many devices may comprise relatively small displays (e.g., a tablet device may comprise a 7″ screen), navigating large amounts of content (e.g., content larger than a current display size) may be unintuitive and/or difficult for a user. A user's experience may be further diminished when content is not organized appropriately for gesture-based interactions.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Among other things, one or more systems and/or techniques for mapping content to a carousel interface are provided herein. A carousel interface may be utilized to display various types of content (e.g., map directions, images, text, search results, videos, news articles, web pages, and/or a plethora of other types of content). The carousel interface may comprise one or more carousels (e.g., the carousels may be organized vertically adjacent to one another, such that a user may vertically scroll the carousel interface to view different carousels using vertical input gestures). A carousel may be configured to comprise one or more pieces of content (e.g., the pieces of content may be organized horizontally adjacent to one another in a scrollable configuration within the carousel, such that a user may horizontally scroll between pieces of content using horizontal input gestures). It may be appreciated that the carousel interface and/or the one or more carousels may be implemented in various configurations (e.g., horizontal, vertical, etc.). The carousel interface may allow a user to navigate and/or interact with content populated within the one or more carousels. In one example of navigating a carousel, a user may scroll between content within a particular carousel without scrolling through content of other carousels (e.g., a user may scroll between finance articles within a finance carousel without scrolling through an entertainment carousel, a world news carousel, and/or other carousel within the carousel interface).

It may be advantageous to structure the content that is populated within the carousel interface (e.g., content structured based upon a domain, one or more categories, entities, and/or topics). Displaying the structured content within the carousel interface may allow a user to intuitively navigate and/or interact with such content populated within the carousel interface. In one example of mapping content to a carousel interface, a domain may be identified (e.g., a news domain, a map directions domain, a weather domain, a search results domain, etc.). For example, a user selection of a news domain within a news application may be received. One or more categories associated with the domain may be identified (e.g., an entertainment news category, a sports news category, a world news category, a finance news category, etc.). The one or more categories may be predefined and/or may be calculated on the fly (e.g., a classification and/or trending technique may be executed upon the domain to identify the one or more categories).

For respective categories, a set of contents relating to a category may be retrieved. For example, a set contents for a sports news category may comprise sports news articles retrieved from a search engine and/or sports news images retrieved from an image database. In one example, content associated with a topic (e.g., images of an upcoming College Football Bowl Game) and/or an entity (e.g., a team schedule and/or score results for a National Football Team) associated with the category may be retrieved for inclusion within the set of contents. In this way, the set of contents may comprise content structured according to a domain (e.g., news), one or more categories (e.g., sports news, entertainment news, finance news, etc.), entities (e.g., Dan's Bike Company, Actress Emily, National Football Team, and/or other proper nouns), and/or topics (e.g., a user defined interest in a new video game, an upcoming College Football Bowl Game, etc.). Structuring the set of contents for inclusion within the carousel interface may allow a user to intuitively navigate and/or interact with such content.

The category may be mapped to a carousel within the carousel interface associated with the domain. For example, the sports news category may be mapped to a sports carousel within a news carousel interface. The carousel may be populated with content within the set of contents. For example, the sports news carousel may be populated with sports news stories, spots news images, sports schedules, sports results, and/or other content associated with the sports news category, entities, and/or topics. In this way, one or more carousels may be mapped with categories and/or populated with content associated with such categories in a structured manner (e.g., a finance news carousel may be populated with finance news articles, stock quotes for an entity Dan's Bike Company, and/or with bailout information for a topic The Big Bailout).

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of mapping content to a carousel interface comprising one or more carousels.

FIG. 2 is a component block diagram illustrating an exemplary system for mapping content to a carousel interface comprising one or more carousels.

FIG. 3 is an illustration of an example of a set of contents for populating a carousel interface.

FIG. 4 is an illustration of an example of scrolling between content within a carousel based upon a swipe input on a touch screen device.

FIG. 5 is an illustration of an example of scrolling between carousels within a carousel interface based upon a swipe input on a touch screen device.

FIG. 6 is an illustration of an example of a carousel interface.

FIG. 7 is an illustration of an exemplary computer-readable medium wherein processor-executable instructions configured to embody one or more of the provisions set forth herein may be comprised.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

Applications convey information in a variety of formats. In one example, an operating system may represent applications as interactive tiles. In another example, a weather application may display weather information as weather tiles corresponding to days of the week. In another example, a web search engine may return search results as in a list format. Unfortunately, many devices (e.g., smart phones, tablet devices, laptops, etc.), may comprise relatively small screens, which may inhibit the ability to adequately convey information to a user using conventional formats. Because many of these devices may support gesture-based interactions (e.g., finger swipes on a touch screen), new techniques for structuring, displaying, and/or navigating content may be advantageous.

Accordingly, one or more systems and/or techniques for mapping content to a carousel interface are provided herein. In particular, content may be structured according to a domain (e.g., retail shopping store results within a map domain), one or more categories associated with the domain (e.g., clothing stores, restaurants, exercise stores, video game stores, local shopping trends, coupons, etc.), entities (e.g., Dan's Bike Company, Emily's Coffee Shop, and/or other proper nouns), and/or topics (e.g., Christmas Shopping Season, Extreme Couponing, etc.). The content may be mapped to one or more carousels within the carousel interface. In one example, holiday hours and specials for the entity Dan's Bike Company, locations of exercise stores, sports equipment buying articles, and/or other content associated with an exercise store category, topic, and/or entity may be mapped to an exercise store carousel within a shopping domain carousel interface. In another example, locations of video game stores, upcoming video game releases, video game commercials for the Christmas Shopping Season, and/or other content associated with a video game store category, topic, and/or entity may be mapped to a video game carousel within the shopping domain carousel interface. In this way, a user may intuitively navigate, locate, and/or interact with content mapped to the shopping domain carousel interface (e.g., a user may navigate between various carousels using vertical input, the user may navigate between content within a carousel using horizontal input, etc.). It may be appreciated that the carousel interface may be implemented for a variety of interfaces (e.g., an operating system, a website interface, an application, search engine results, etc.) and/or form factors (e.g., a tablet device, a desktop device, a touch screen device, a mobile device, a smart phone, etc.).

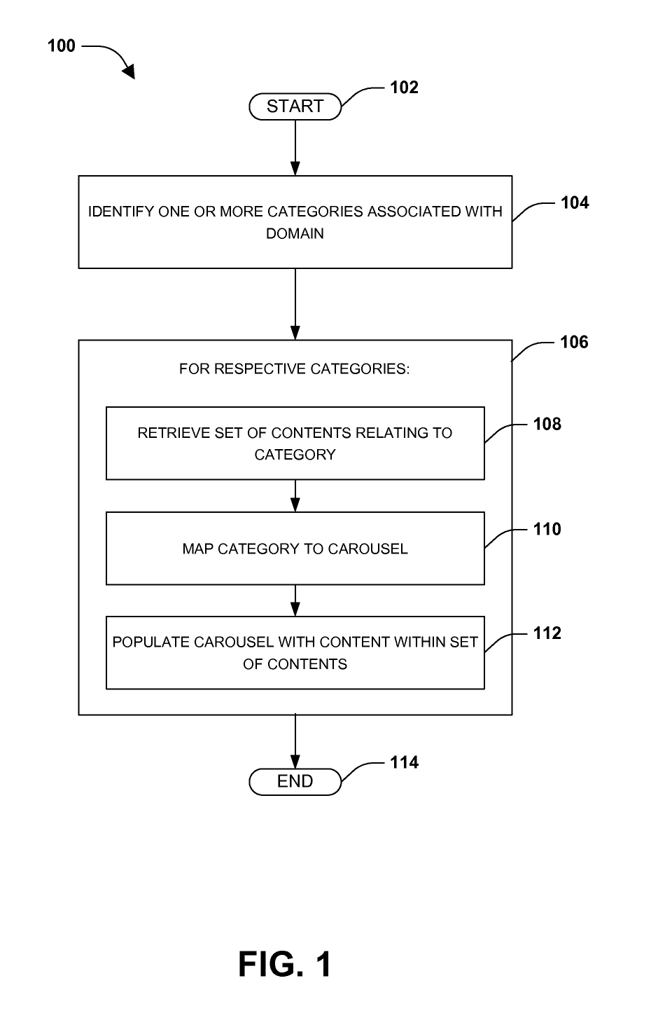

One embodiment of mapping content to a carousel interface comprising one or more carousels is illustrated by an exemplary method 100 in FIG. 1. At 102, the method starts. A carousel interface may comprise one or more carousels for displaying content (e.g., news articles, images, driving directions, search engine results, videos, text, and/or a plethora of other information). In one example, a carousel may comprise a scrollable interface within which content may be populated (e.g., content within the carousel may be navigated based upon horizontal input, such as a horizontal finger swipe). In one example of a scrollable interface, a user may scroll a particular carousel without scrolling other carousels (e.g., a user may scroll between finance articles within a finance carousel without scrolling an entertainment carousel, a world news carousel, and/or other carousel). In one example of the carousel interface, the one or more carousels may be arranged adjacent to one another (e.g., vertically adjacent, horizontally adjacent, etc.), such that a user may navigate between carousels using gestured input (e.g., vertical input, such as a vertical finger swipe, may be used to navigate between vertically arranged carousels). It may be appreciated that the carousel interface and/or the one or more carousels may be implemented in various configurations (e.g., horizontal, vertical, etc.).

It may be advantageous to structure content (e.g., into a domain, one or more categories, topics, entities, etc.) for population into the carousel interface. Accordingly, one or more categories associated with a domain may be identified, at 104. For example, the carousel interface may be associated with the domain (e.g., news carousel interface for a news domain). One or more categories (e.g., world news, finance news, sports news, etc.) associated with the news domain may be identified (e.g., a category may be predefined and/or a category may be identified based upon executing a classification technique upon the domain).

At 106, for respective categories, a set of contents relating to a category may be retrieved, at 108. For example, sports articles, sports images, sports videos, and/or other content may be retrieved for the sports news category (e.g., content may be retrieved from any one or more of a search engine, a microblog, a social network, a database, a bloc, etc.). It may be appreciated that content may be identified for inclusion within the set of contents based upon a variety of criteria (e.g., such that the set of contents may be structured based upon such criteria). In one example, a topic associated with the category may be identified, and content associated with the topic may be retrieved for inclusion within the set of contents (e.g., articles and/or images associated with a Super Bowl topic may be retrieved). The topic may correspond to a user defined interest (e.g., a user may select a topic of Super Bowl), an algorithmically defined topic (e.g., a classification and/or trending technique may identify 2012 Olympics as a topic based upon content crawled from the internet), and/or an editorially defined topic (e.g., an editor may program a topic of football concussions). In another example, an entity associated with the category may be identified, and content associated with the entity may be retrieved for inclusion within the set of contents (e.g., a team schedule and/or score results for a National Football Team may be retrieved). The entity may correspond to an algorithmically defined topic (e.g., a classification and/or trending technique may identify a National Football Team as a professional football team based upon identifying the National Football Team as a keyword and/or proper noun) and/or an editorially defined topic (e.g., an editor may program an entity of Dan's Bakery Shop).

At 110, the category may be mapped to a carousel within the carousel interface associated with the domain. For example, the sports news category may be mapped to a sports carousel within the carousel interface. In this way, the carousel interface may comprise one or more carousels corresponding to the one or more categories. At 112, the carousel may be populated with content within the set of contents. In one example of populating a horizontally configured scrollable sports carousel, a first sports article may be populated in a first position within the sports carousel, a second sports article may be populated in a second position horizontally adjacent to the first position within the sports news carousel, a sports image may be populated in a third position horizontally adjacent to the second position within the sports news carousel, etc. In one example, content may be ordered for inclusion within the carousel based upon time, user preference, similarity, relevance, etc. (e.g., sports articles may be populated within the sports news carousel based upon publication date, relevance to the sports news category, etc.). Because similar content may be retrieved from multiple sources, first content from a first source may be aggregated with second content from a second source to create aggregated content, which may be populated within (e.g., one or more positions within) the carousel.

Navigation and/or user interactions with content populated within the carousel interface may be facilitated. In one example where carousels are configured vertically adjacent within the carousel interface and content is configured horizontally adjacent within respective carousels, the carousel interface may vertically rotate from a first carousel to a second carouse responsive to vertical input (e.g., a vertical finger swipe). In this way, a user may scroll between various carousels within the carouse interface. A carousel within the carousel interface may be horizontally scrolled between first content and second content responsive to horizontal input (e.g., a horizontal finger sweep). In one example, the carousel may be horizontally scrolled, while other carousels may not be scrolled (e.g., one out of three carousels may be scrolled). In this way, a user may scroll between content of a carousel without affected content displayed within other carousels. In another example, one or more carousels may be scrolled based upon horizontal input (e.g., two visible out of three total carousels may be scrolled, three out of three carousels may be scrolled, etc.).

In another example of facilitating user interactions, content within a carousel may be associated with a source of the content (e.g., a sports article may be linked to a web page comprising the sports article). Responsive to a selection input of the content through the carousel interface, the user may be navigated to the source of the content (e.g., taken to a web page through a browser). In another example of facilitating user interactions, the one or more carousels may be reordered within the carousel interface responsive to a reorder input (e.g., a first carousel may be vertically ordered relative to a second carousel based upon a drag/drop operation). In this way, structured content may be populated, navigated, and/or interacted with through the carousel interface. At 114, the method ends.

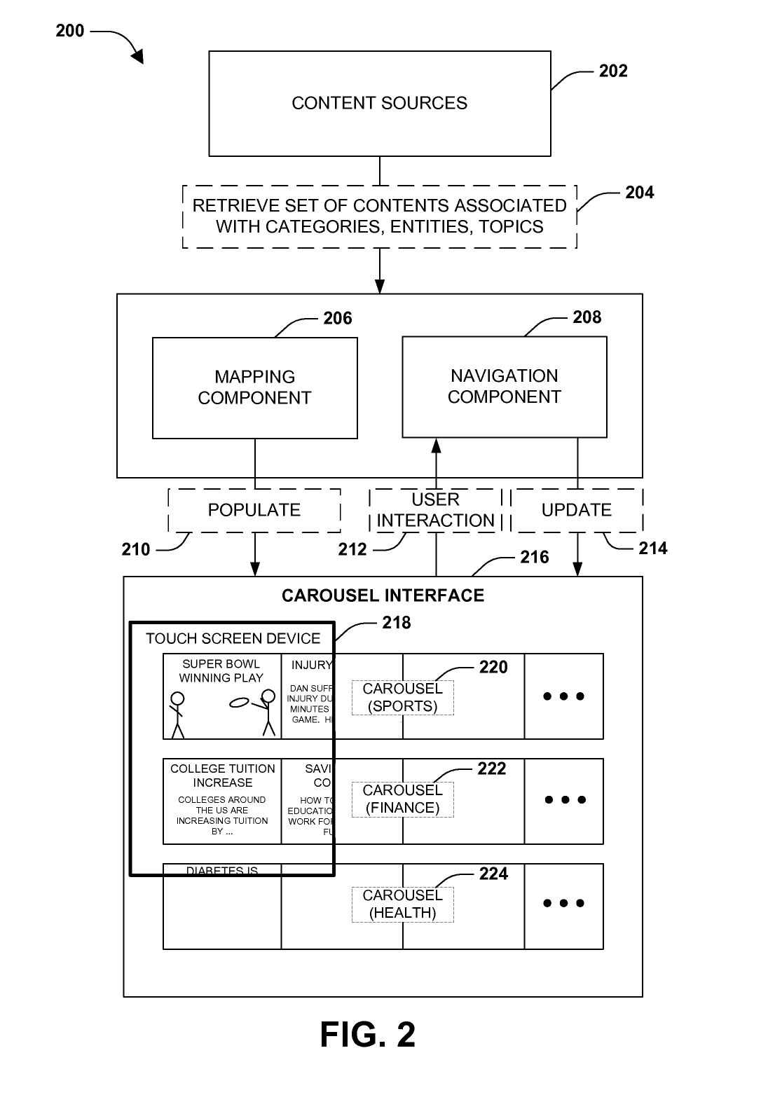

FIG. 2 illustrates an example of a system 200 configured for mapping content to a carousel interface 216 comprising one or more carousels. A carousel interface, such as carousel interface 216, may comprise an interface associated with a variety of applications (e.g., a news application, a map application, a search results engine, an image application, a web service, etc.), form factors (e.g., a tablet device, a desktop device, a touch screen device, a mobile device, etc.) and/or domains (e.g., a map directions domain, a search engine results domain, a news domain, an image gallery domain, a video gallery domain, a social media domain, etc.). In one example, the carousel interface 216 may correspond to a news domain associated with a news application hosted on a touch screen device 218. The carousel interface 216 may comprise one or more carousel, such as a sports carousel 220, a finance carousel 222, a health carousel 224, and/or other carousels not illustrated. In one example, the one or more carousels may be vertically configured within the carousel interface 216 to allow for vertical scrolling between carousels. In another example not illustrated, the one or more carousels may be horizontally configured within the carousel interface 216 to allow for horizontal scrolling between carousels.

The system 200 may comprise a mapping component 206 configured to retrieve a set of contents 204 associated with one or more categories, entities, and/or topics from one or more content sources 202. In particular, the mapping component 206 may be configured to identify one or more categories associated with the domain (e.g., a sports category, a finance category, a health category, and/or other categories may be associated with the news domain). In one example, one or more topics (e.g., Super Bowl, 2012 Olympics, etc.) and/or one or more entities (e.g., Dan's Cake Shop, National Football Team, and/or other proper nouns) for the category may be identified. In one example, an entity and/or topic may be identified based upon a classification and/or trending analysis of available content (e.g., content retrieved from a web crawler) that identifies keywords and/or other information. In another example, an entity and/or topic may be editorially defined and/or user specified.

For respective categories, the mapping component 206 may be configured to retrieve a set of contents (e.g., the set of contents 204) associated with a category (e.g., and/or associated with entities and/or topics related to the category). The mapping component 206 may map the category to a carousel within the carousel interface 216 (e.g., the sports category may be mapped to the sports carousel 220). The mapping component 206 may populate 210 the carousel with content within the set of contents 204. For example, a Super Bowl winning play image, a sports injury article, and/or other content not illustrated may be mapped to the sports carousel 220. In one example, the content may be ordered for inclusion within the carousel based upon time, user preference, similarity, and/or relevance. In this way, one or more carousels may be mapped to categories (or vice versa) and/or may be populated with content associated with such categories, entities, and/or topics.

The system 200 may comprise a navigation component 208. The navigation component 208 may be configured to facilitate navigation and/or user interaction 212 within the carousel interface 216. In one example, the carousel interface 216 may be displayed within the touch screen device 218. Because the carousel interface 216 may comprise more content than the touch screen device 218 can display at one time, the navigation component 208 may be configured to vertically scroll (e.g., update 214) between carousels based upon vertical input (e.g., the navigation component 208 may scroll from the sports carousel 220 to the finance carousel 222 and/or the health carousel 224 based upon a vertical finger swipe on the touch screen device 218). The navigation component 208 may be configured to horizontally scroll (e.g., update 214) between content within a carousel based upon horizontal input (e.g., the navigation component 208 may scroll from a Super Bowl image to a football injury article within the sports carousel 220 based upon a horizontal finger swipe on the touch screen device 218). In one example, scrolling of a first carousel may not scroll a second carousel (e.g., horizontal scrolling of the sports carousel 220 may not horizontally scroll the finance carousel 222). In this way, a user may be able to navigate and/or interact with structured content (e.g., content structured based upon the domain, one or more categories, entities, and/or topics) populated within the carousel interface 216.

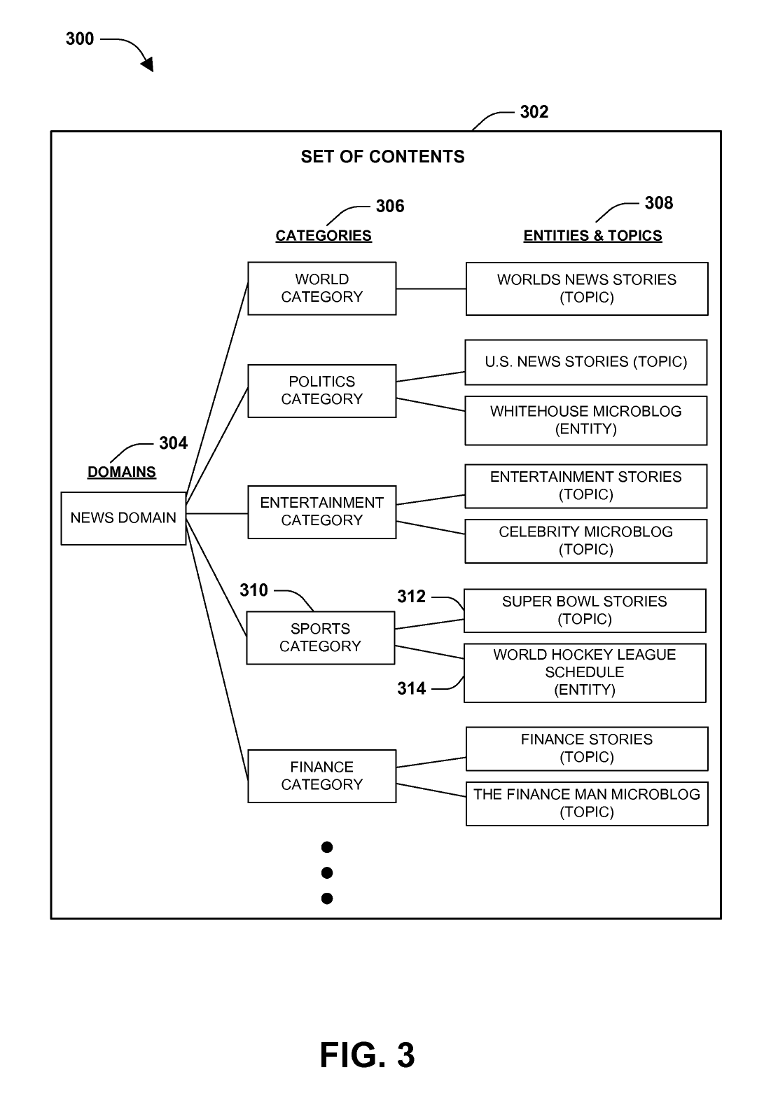

FIG. 3 illustrates an example 300 of a set of contents 302 for populating a carousel interface. The set of contents 302 may be associated with a domain 304, such as a news domain, associated with the carousel interface. The domain 304 may be associated with one or more categories 306 (e.g., a world category, a politics category, an entertainment category, a sports category 310, a finance category, and/or other categories associated with the news domain). One or more entities and/or topics (e.g., entities and topics 308) may be associated with a category. For example, a Super Bowl topic 312 may be associated with the sports category 310, such that content, such as Super Bowl stories, may be retrieved as content for the Super Bowl topic 312. A World Hockey League entity 314 may be associated with the sports category 310, such that content, such as a World Hockey League schedule, may be retrieved as content for the World Hockey League entity 314. In this way, content may be structured according to the one or more categories 306, one or more entities, and/or one or more topics within the set of contents 302 for populating the carousel interface.

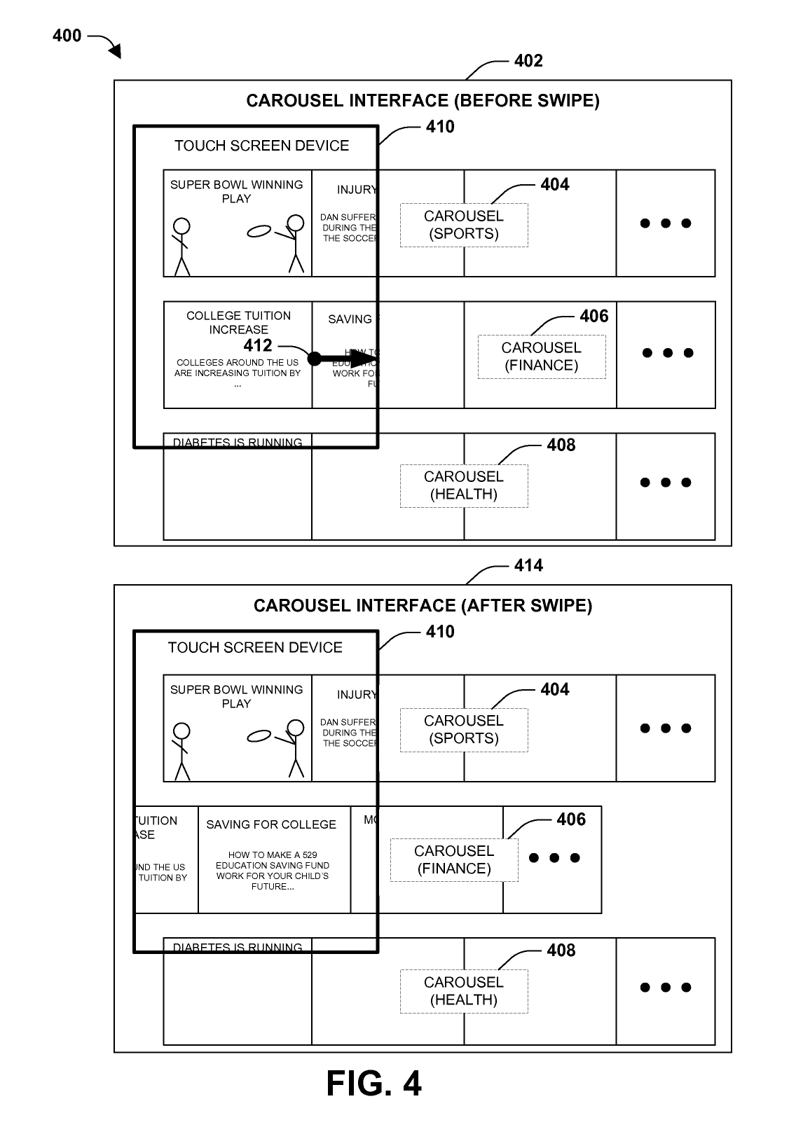

FIG. 4 illustrates an example 400 of scrolling between content within a carousel based upon a swipe input 412 on a touch screen device 410. The touch screen device 410 may display at least a portion of a carousel interface (e.g., carousel interface before swipe 402) comprising one or more carousels, such as sports carousel 404, finance carousel 406, health carousel 408, and/or other carousels not illustrated. Because the carousel interface may comprise more content than the touch screen device 410 can display at one time, vertical scrolling between carousels within the carousel interface and/or horizontal scrolling between content within a carousel may be facilitated. In one example of scrolling between content within a carousel, the swipe input 412 on the touch screen device 410 may be received. The swipe input 412 may correspond to the finance carousel 406 (e.g., but not the sports carousel 404 and/or the health carousel 408). Accordingly, content within the finance carousel 406 may be scrolled (e.g., right to left) based upon the swipe input 412. For example the college tuition increase article may scroll to the left out of view, while the savings for college article may scroll to the left into view. In one example, the sports carousel 404, the health carousel 408, and/or other carousels not illustrate may not be scrolled because the swipe input 412 did not correspond to such carousels. In this way, the touch screen device 410 may display the carousel interface after swipe 414.

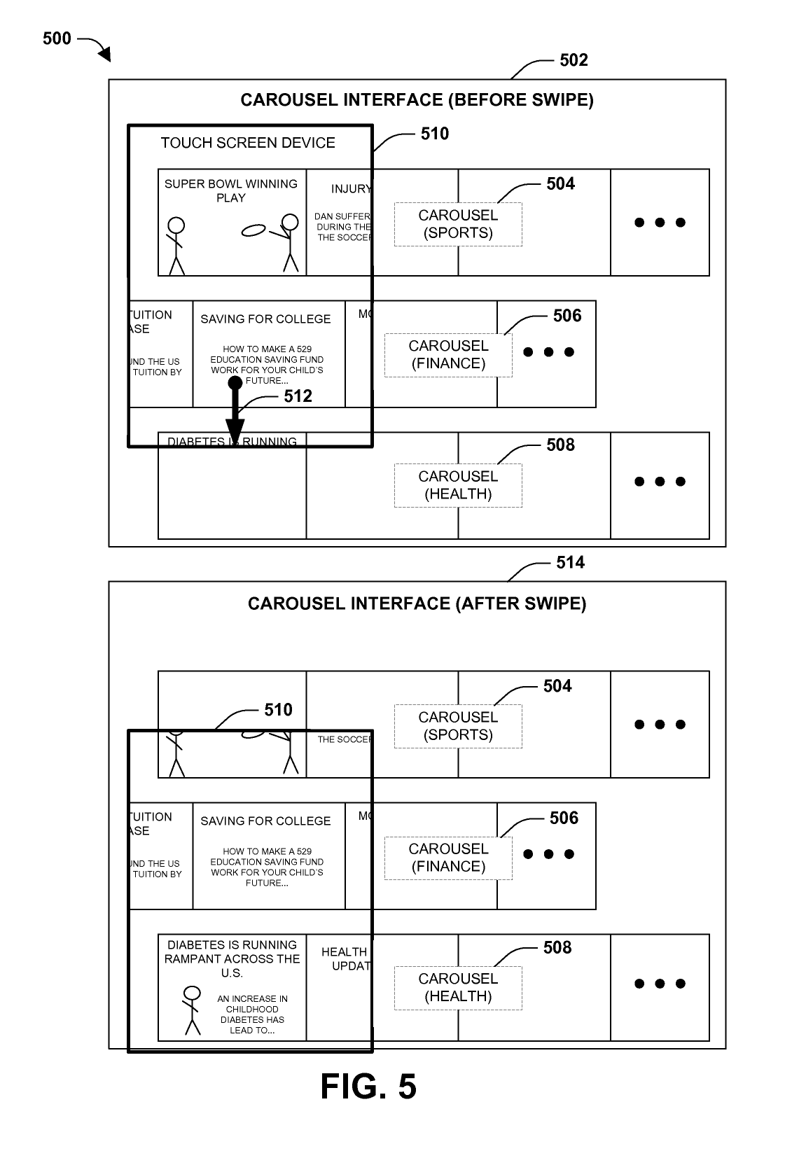

FIG. 5 illustrates an example 500 of scrolling between carousels within a carousel interface based upon a swipe input 512 on a touch screen device 510. The touch screen device 510 may display at least a portion of the carousel interface (e.g., carousel interface before swipe 502) comprising one or more carousels, such as sports carousel 504, finance carousel 506, health carousel 508, and/or other carousels not illustrated. Because the carousel interface may comprise more carousels than the touch screen device 510 can display at once, vertical scrolling between carousels within the carousel interface may be facilitated. In one example of scrolling between carousels, the swipe input 512 on the touch screen device 510 may be received. The swipe input 512 may correspond to a vertical downward swipe across the carousel interface. Responsive to the swipe input 512, carousels within the carousel interface may be vertically scrolled. For example, a portion of the sports carousel 504 may be vertically scrolled up out of view, the finance carousel 506 may be vertically scrolled up, and the health carousel 508 may be vertically scrolled up into full view within the carouse interface. In this way, the touch screen device 510 may display the carousel interface after swipe 514.

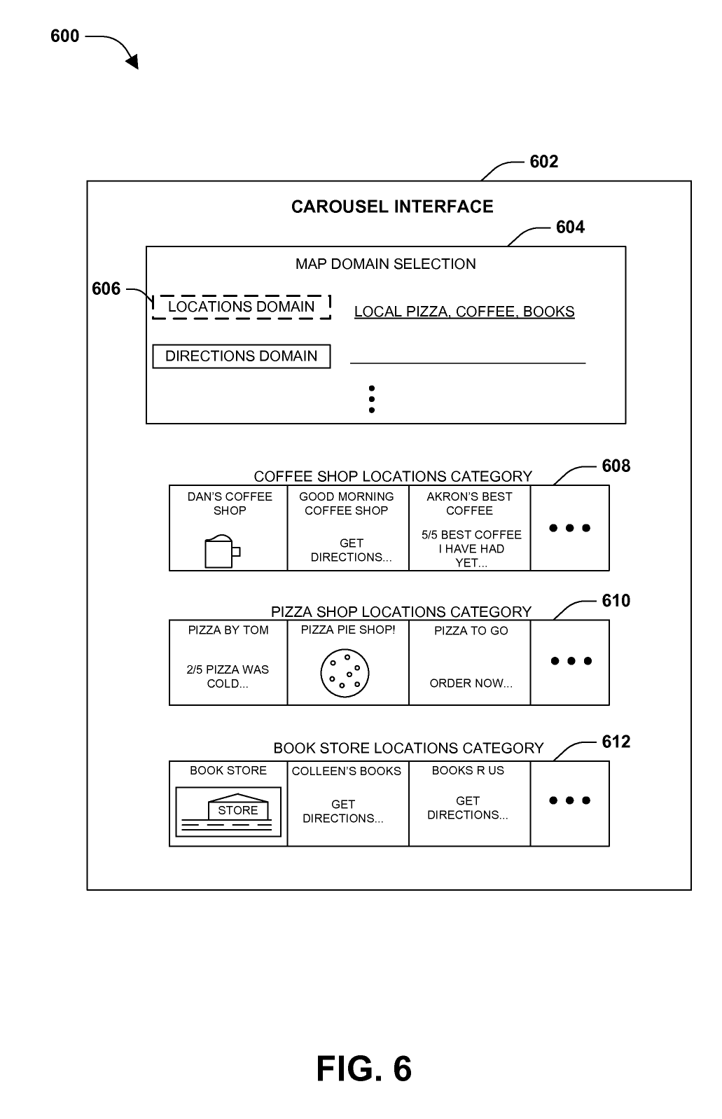

FIG. 6 illustrates an example 600 of a carousel interface 602. It may be appreciated that a carousel interface (e.g., carousel interface 602) may correspond to a variety of applications (e.g., a mapping application, a search engine, a news application, etc.), form factors (e.g., a desktop, a mobile device, a tablet device, etc.), and/or domains (e.g., news domain, directions domain, locations domain, image search engine results domain, website search engine results domain, etc.). In one example, the carousel interface 602 may correspond to a mapping application. The mapping application may be associated with a map domain selection interface 604 (e.g., an input bar). The map domain selection interface 604 may be configured to allow a user to search for directions by selecting a directions domain and inputting a From/To query. Accordingly, content associated with the directions domain and the From/To query may be retrieved and populated within one or more carousels of the carousel interface 602.

The mapping application may allow a user to search for locations by selecting a locations domain 606 and inputting a search query (e.g., a “local pizza, coffee, books” search query). Accordingly, one or more categories associated with the locations domain 606 and/or the “local pizza, coffee, books” search query may be identified (e.g., a pizza shop category, a coffee shop category, a book store category, etc.). Content associated with the one or more categories may be retrieved. One or more carousels within the carousel interface 602 may be mapped to the one or more categories, and may be populated with corresponding content. For example, a coffee shop carousel 608 may be mapped to the coffee shop category and/or populated with content associated with the coffee shop category. A pizza shop carousel 610 may be mapped to the pizza shop category and/or populated with content associated with the pizza shop category. A book store carousel 612 may be mapped to the book store category and/or populated with content associated with the book store category. In this way, the carousel interface 602 may be populated with structured content. Carousels of the carousel interface could similarly be populated with directions for a mapping application. For example, the first carousel could be populated with turn by turn/point by point directions of a first route from a starting location to a destination location, the second carousel could be populated with turn by turn/point by point directions of a second route from a starting location to a destination location, the third carousel could be populated with information about points of interest (e.g., rest stops, stores, coffee shops, etc.) along one or more of the routes, and so on. That is, the instant application, including the scope of the appended claims, contemplates more than, and thus is not intended to be limited to, the examples provided herein.

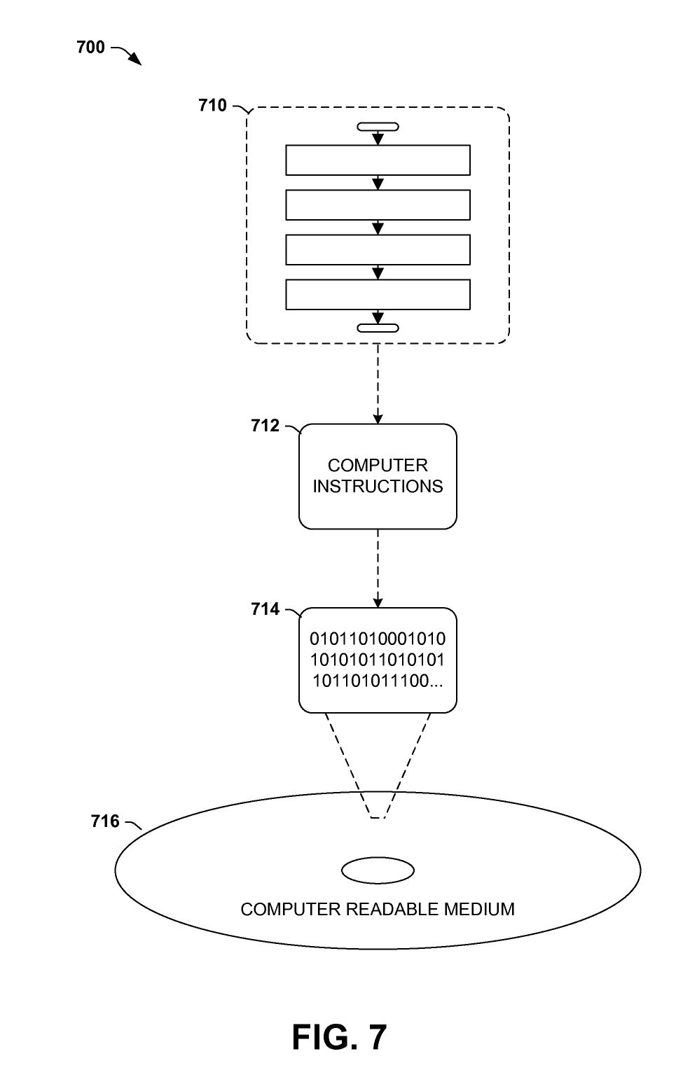

Still another embodiment involves a computer-readable medium comprising processor-executable instructions configured to implement one or more of the techniques presented herein. An exemplary computer-readable medium that may be devised in these ways is illustrated in FIG. 7, wherein the implementation 700 comprises a computer-readable medium 716 (e.g., a CD-R, DVD-R, or a platter of a hard disk drive), on which is encoded computer-readable data 714. This computer-readable data 714 in turn comprises a set of computer instructions 712 configured to operate according to one or more of the principles set forth herein. In one such embodiment 700, the processor-executable computer instructions 712 may be configured to perform a method 710, such as at least some of the exemplary method 100 of FIG. 1, for example. In another such embodiment, the processor-executable instructions 712 may be configured to implement a system, such as at least some of the exemplary system 200 of FIG. 2, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

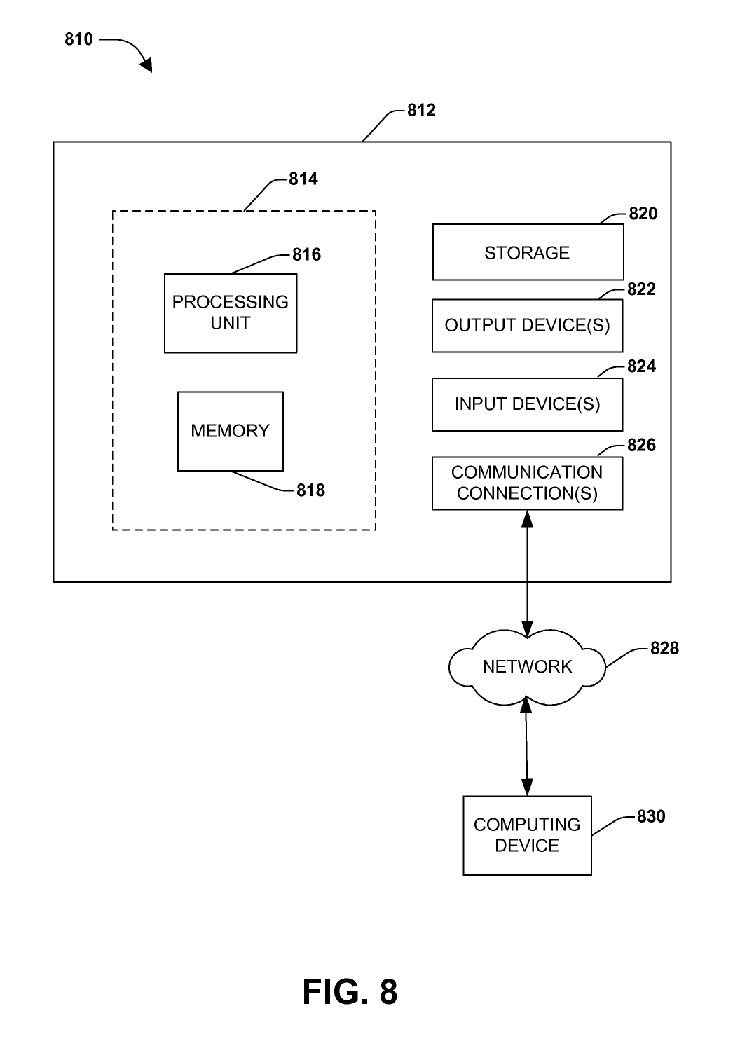

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 810 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example) or some combination of the two. This configuration is illustrated in FIG. 8 by dashed line 814.

In other embodiments, device 812 may include additional features and/or functionality. For example, device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Any such computer storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 812. Input device(s) 824 and output device(s) 822 may be connected to device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via a network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B and/or the like generally means A or B or both A and B.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

1. A method for mapping content to a carousel interface comprising one or more carousels, comprising:
identifying one or more categories associated with a domain; and
for respective categories;
retrieving a set of contents relating to a category;
mapping the category to a carousel within a carousel interface associated with the domain; and
populating the carousel with content within the set of contents.

2. The method of claim 1, the identifying comprising:
executing a classification technique upon the domain to identify the one or more categories.

3. The method of claim 1, the retrieving comprising:
identifying a topic associated with the category; and
retrieving content associated with the topic for inclusion within the set of contents.

4. The method of claim 3, the topic corresponding to a user defined interest.

5. The method of claim 1, the retrieving comprising:
identifying an entity associated with the category; and
retrieving content associated with the entity for inclusion within the set of contents.

6. The method of claim 5, the identifying an entity comprising:
identifying a keyword based upon executing a trending analysis technique.

7. The method of claim 1, the populating comprising:
ordering the content for inclusion within the carousel based upon at least one of time, user preference, similarity, and relevance.

8. The method of claim 1, the set of contents comprising at least one of social network content, microblog content, and blog content.

9. The method of claim 1, the populating comprising at least one of:
aggregating first content from a first source with second content from a second source to create aggregated content, the first content and the second content within the set of contents; and
populating the carousel with the aggregated content.

10. The method of claim 1, comprising:
facilitating navigation of content associated with the one or more categories of the domain through the carousel interface.

11. The method of claim 10, the facilitating navigation comprising:
responsive to a vertical input through the carousel interface, vertically rotating from a first carousel to a second carousel; and
responsive to a horizontal input of a carousel through the carousel interface, horizontally rotating from first content to second content within the carousel.

11. (canceled)

12. The method of claim 1, comprising:
responsive to a reorder input through the carousel interface, vertically ordering a first carousel relative to a second carousel within the carousel interface.

13. A system for mapping content to a carousel interface comprising one or more carousels, comprising:
a mapping component configured to:
identify one or more categories associated with a domain; and
for respective categories;
retrieve a set of contents relating to a category;
map the category to a carousel within a carousel interface associated with the domain; and
populate the carousel with content within the set of contents.

14. The system of claim 13, the mapping component configured to:
identify a topic associated with the category; and
retrieve content associated with the topic for inclusion within the set of contents.

15. The system of claim 13, the mapping component configured to:
identify an entity associated with the category; and
retrieve content associated with the entity for inclusion within the set of contents.

16. The system of claim 15, the mapping component configured to:
identify a keyword when identifying the entity based upon executing a trending analysis technique.

17. The system of claim 13, the mapping component configured to:
order the content for inclusion within the carousel based upon at least one of time, user preference, similarity, and relevance.

18. The system of claim 13, comprising:
a navigation component configured to:
facilitate navigation of content associated with the one or more categories of the domain through the carousel interface.

19. The system of claim 18, the navigation component configured to:
responsive to a vertical input through the carousel interface, vertically rotate from a first carousel to a second carousel; and
responsive to a horizontal input of a carousel through the carousel interface, horizontally rotate from first content to second content within the carousel.

20. A computer-readable medium comprising processor-executable instructions that when executed perform a method for mapping content to a carousel interface comprising one or more carousels, comprising:
identifying one or more categories associated with a domain; and
for respective categories;
retrieving a set of contents relating to a category;
mapping the category to a carousel within a carousel interface associated with the domain; and
populating the carousel with content within the set of contents.
